(19) United States
(12) Patent Application Publication
(10) Pub. No.: US 2022/0392101 A1
(43) Pub. Date: Dec. 8, 2022

(54) TRAINING METHOD, METHOD OF DETECTING TARGET IMAGE, ELECTRONIC DEVICE AND MEDIUM

(71) Applicant: BEIJING BAIDU NETCOM SCIENCE TECHNOLOGY CO., LTD., Beijing (CN)

(72) Inventors: Zipeng LU, Beijing (CN); Jian WANG, Beijing (CN); Hao SUN, Beijing (CN); Errui DING, Beijing (CN)

(73) Assignee: BEIJING BAIDU NETCOM SCIENCE TECHNOLOGY CO., LTD., Beijing (CN)

(21) Appl. No.: 17/887,740

(22) Filed: Aug. 15, 2022

(30) Foreign Application Priority Data
Aug. 20, 2021 (CN) 202110964915.4

(51) Int. Cl. G06T 7/70; G06T 7/62; G06V 10/25; G06V 10/74; G06V 10/774

(52) U.S. Cl. CPC G06T 7/70; G06T 7/62; G06V 10/25; G06V 10/761; G06V 10/774; G06V 2201/07; G06T 2207/20081

(57) ABSTRACT

A training method, a method of detecting a target image, an electronic device and a medium, which relate to the field of artificial intelligence technology, and in particular to fields of computer vision and deep learning. The method can include: generating an expanded sample image set for a target scene by using a mask image set and an initial sample image set, wherein the mask image set is acquired by parsing a predetermined image set, a target object in the target scene is interfered by another object or the target object in the target scene is cut off, and an image in the predetermined image set includes the target object in the target scene or the another object; and training, by using the initial sample image set and the expanded sample image set, a detection model for detecting the target object.

This application claims the priority of Chinese Patent Application No. 202110964915.4 filed on Aug. 20, 2021, the whole disclosure of which is incorporated herein by reference.

### TECHNICAL FIELD

The present disclosure relates to a field of artificial intelligence technology, and in particular to fields of computer vision and deep learning. Specifically, the present disclosure relates to a training method, a method of detecting a target image, an electronic device and a medium.

### BACKGROUND

With the improvement of computer hardware performance and the emergence of large-scale image data, deep learning has been widely used in the field of computer vision. A target detection task is one of the tasks in the field of computer vision.

Target detection refers to detecting, from an image to be detected, a target object and a position of the target object in the image to be detected. The image to be detected may be images in various scenes.

### SUMMARY

The present disclosure provides a training method, a method of detecting a target image, an electronic device and a medium.

According to an aspect of the present disclosure, there is provided a method of training a detection model, the method including: generating an expanded sample image set for a target scene by using a mask image set and an initial sample image set, wherein the mask image set is acquired by parsing a predetermined image set, a target object in the target scene is interfered by another object or the target object in the target scene is cut off, and an image in the predetermined image set includes the target object in the target scene or said another object; and training a detection model, by using the initial sample image set and the expanded sample image set, for detecting the target object.

According to an aspect of the present disclosure, there is provided a method of detecting a target image, the method including: acquiring an image to be detected; and inputting the image to be detected into a detection model to acquire a detection result, wherein the detection model is trained by using the method described above.

According to an aspect of the present disclosure, there is provided an electronic device, including: at least one processor; and a memory communicatively connected with the at least one processor; wherein the memory stores instructions executable by the at least one processor, and the instructions, when executed by the at least one processor, cause the at least one processor to implement the method described above.

According to another aspect of the present disclosure, there is provided a non-transitory computer-readable storage medium having computer instructions stored therein, the computer instructions are configured to cause a computer system to implement the method described above.

It should be understood that the contents described in this section is not intended to identify key or critical features of embodiments of the present disclosure, nor is it intended to limit the scope of the present disclosure. Other features of the present disclosure will become readily understood from the following descriptions.

### BRIEF DESCRIPTION OF THE DRAWINGS

The appending drawings are for a better understanding of the present disclosure, rather than limiting the present disclosure, in which:

FIG. 1 schematically shows an exemplary system architecture according to an embodiment of the present disclosure, in which a method and an apparatus of training a detection model, a method and an apparatus of detecting target image may be applied.

FIG. 2 schematically shows a flowchart of a method of training a detection model according to an embodiment of the present disclosure.

FIG. 3 schematically shows a schematic diagram of a process of training a detection model according to an embodiment of the present disclosure.

FIG. 4 schematically shows a flowchart of generating an expanded sample image set for a target scene by using a mask image set and an initial sample image set, according to an embodiment of the present disclosure.

FIG. 5 schematically shows a schematic diagram of a process of generating a cutoff sample image according to an embodiment of the present disclosure.

FIG. 6 schematically shows a schematic diagram of a process of generating a first crowded occlusion image according to an embodiment of the present disclosure.

FIG. 7 schematically shows a schematic diagram of a process of generating a second occlusion sample image according to an embodiment of the present disclosure.

FIG. 8 schematically shows a flowchart of a method of detecting a target image according to an embodiment of the present disclosure.

FIG. 9 schematically shows a block diagram of an apparatus of training a detection model according to an embodiment of the present disclosure.

FIG. 10 schematically shows a block diagram of an apparatus of detecting a target image according to an embodiment of the present disclosure.

FIG. 11 schematically shows a block diagram of an electronic device suitable for a method of training a detection model or a method of detecting a target image according to an embodiment of the present disclosure.

### DETAILED DESCRIPTION OF EMBODIMENTS

Exemplary embodiments of the present disclosure are described below with reference to the accompanying drawings, in which various details of embodiments of the present disclosure are included to facilitate understanding, and they should be considered as exemplary only. Accordingly, those of ordinary skill in the art will recognize that various changes and modifications of embodiments described here may be made without departing from the scope and spirit of the present disclosure. Also, descriptions of well-known functions and constructions are omitted from the following descriptions for clarity and conciseness.

Target detection may be achieved by using a target detection model obtained based on deep learning training. For target detection in a simple scene, a better prediction accuracy of the target detection model may be ensured. The simple scene may refer to a scene in which a target object is easier to be detected, e.g., a scene in which various parts of a target object in the scene are complete and having no overlap with another object. For object detection in a complicated scene, the prediction accuracy of the target detection model is not high. The complicated scene may refer to a scene in which the target object is difficult to be detected. For example, in a complicated scene, the target object is interfered by another object or the target object is cut off. The scene in which the target object is interfered by another object may include at least one of: a crowded scene and an occlusion scene. The scene in which the target object is cut off may refer to a cutoff scene. The target object may include a human body. For example, if a degree of occlusion of two target objects in an image is large, there may be missed detection or inaccurate detection, which may reflect that the prediction accuracy of the target detection model is not high for the target detection in the complicated scene.

The reason why the target detection model may ensure the better prediction accuracy for simple scenes but not for complicated scenes is that a number of sample images of the simple scenes and a number of sample images of the complicated scenes are not balanced, that is, the number of the sample images of the simple scenes is larger than the number of the sample images of the complicated scenes, which results in that the model may better learn features of the sample images of the simple scenes, but it is more difficult to learn features of the sample images of the complicated scenes with the smaller number. Therefore, the prediction accuracy of the target detection model in the complicated scenes is not high.

In order to improve the prediction accuracy of the target detection model in the complicated scenes, the problem of unbalanced numbers of the sample images in the simple scenes and in the complicated scenes should be solved. To this end, a sample balancing strategy may be used. The sample balancing strategy may include at least one of: a data balancing strategy and an algorithmic balancing strategy. The data balancing strategy may refer to a strategy used to achieve relatively balanced numbers of sample images of different categories in a sample image set. The algorithmic balancing strategy may refer to a strategy used to achieve a sample balancing without changing the numbers of sample images of different categories.

If the data balancing strategy is implemented, a method of increasing the number of the sample images in the complicated scenes may be used, and specifically, the following manners may be used.

In a first manner, the number of the sample images in difficult samples is increased by means of additionally acquiring sample images in the complicated scenes. That is, for the complicated scenes, on the basis of keeping the original sample images unchanged, sample images in the complicated scenes are additionally acquired, and the number of the sample images in the complicated scenes is increased to improve the prediction accuracy of the target detection model for the complicated scenes. This is because that, by increasing the number of the sample images in the complicated scenes, the number of the sample images in the simple scenes and the number of the sample images in the complicated scenes may be balanced as much as possible, so that the target detection model obtained by training may better learn features of the sample images in the complicated scenes on a basis of features of the sample images in the simple scenes being well learnt, thereby improving the prediction accuracy of the target detection model for the complicated scenes.

In a second manner, the number of the difficult sample images is increased by means of a data augmentation algorithm. That is, the data augmentation algorithm is used to process the original sample images to obtain augmented sample images, and the target detection model is trained by using the augmented sample images and the original sample images to improve the prediction accuracy of the target detection model. The data augmentation algorithm may include at least one of: translation, rotation, clipping, non-rigid transformation, noise perturbation, and color transformation.

If the algorithm balancing strategy is implemented, a detection algorithm may be improved.

In a process of achieving a concept of the present disclosure, it is found that regarding the first manner for the data balancing strategy, an acquiring cost is increased due to a great difficulty in acquiring the sample images in the complicated scenes.

Regarding the second manner for the data balancing strategy, if the used original sample images are not the sample images in the complicated scenes, it is difficult to obtain new sample images in the complicated scenes by using the data augmentation algorithm to process the original images. If the used original sample images are the sample images in the complicated scenes, there may be distortions in some areas of the image due to the data augmentation algorithm. Thus, image qualities of the augmented sample images obtained based on the data augmentation algorithm is not high, and it is difficult for the augmented sample images to be used as sample images of the training model. Thus, it is also difficult to improve the prediction accuracy of the target detection model for the complicated scenes by using the second manner.

For the algorithmic balancing strategy, the improved detection algorithm may involve a design of a complicated trick, an implementing difficulty of which is great, and an improving effect of the model is limited.

To this end, embodiments of the present disclosure provide a solution in which the data balancing strategy is used to improve the prediction accuracy of the target detection model for the complicated scenes. The used data balancing strategy is different from the manner of additionally acquiring the sample images in the complicated scenes (i.e., the first manner) and the manner of using the data augmentation algorithm (i.e., the second manner). In the solution of the present disclosure, disclosed predetermined image set is used rather than additionally acquiring the sample images in the complicated scenes, moreover, the data augmentation algorithm is not used in the manner of generating sample images in the complicated scenes. That is, the predetermined image set is used to obtain a mask image set, and the mask image set and an initial sample image set are used to generate an expanded sample image set for a target scene, and the initial sample image set and the expanded sample image set are further used to train the detection model for detecting a target object. The predetermined image set may be a disclosed image set, images in the predetermined image set may include the target object, the target scene may refer to the complicated scene described above.

The expanded sample image set for the target scene is generated by using the mask image set and the initial sample image set, and the mask image set is obtained by using the disclosed predetermined image set, thus the increase of the number of the sample images for the target scene is achieved (i.e., the expanded sample image set for the target scene is obtained) without additional acquisition, and an improvement cost is thereby reduced. In addition, since the expanded sample image set is generated by using the mask image set and the initial sample image set rather than generated by using the data augmentation algorithm to process the initial sample images, distortions in some areas of the image due to the data augmentation algorithm may be reduced as much as possible, thereby improving an image quality of the expanded sample image set (i.e., an image quality of the sample images in the target scene) is effectively ensured. In addition, since the data balancing strategy is implemented, a disclosed training framework is not necessarily modified, i.e., performing an operation of generating the expanded sample image set may be used as a module to be inserted into the disclosed training framework. Thus, the improvement cost may be further reduced. Based on the above contents, on a basis of not increasing the improvement cost as much as possible, the prediction accuracy of the detection model for the target scene is improved due to that the number of the sample images in the target scenes participating in the training of the detection model is increased and due to that the image qualities of the sample images in the target scene are effectively ensured.

It should be noted that, the initial sample image set in embodiments of the present disclosure may be obtained from a disclosed data set, or the obtaining of the initial sample image set is authorized by users corresponding to the sample images.

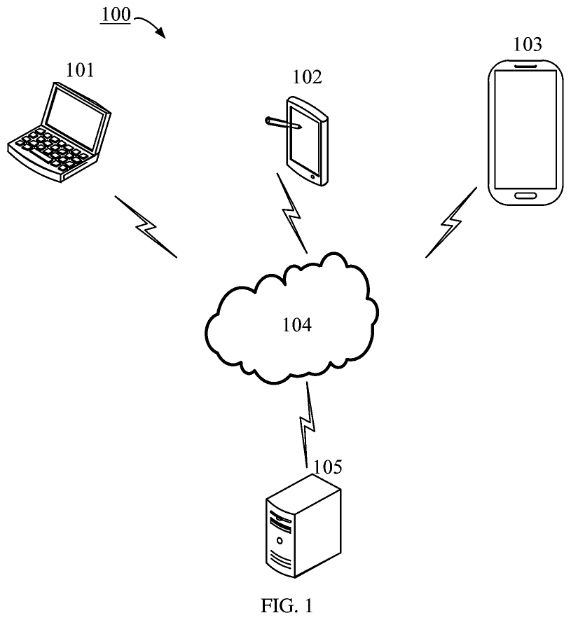

FIG. 1 schematically shows an exemplary system architecture according to an embodiment of the present disclosure, in which a method and an apparatus of training a detection model, a method and an apparatus of detecting target image may be applied.

It should be noted that FIG. 1 only shows an example of a system architecture in which embodiments of the present disclosure may be applied, so as to facilitate those skilled in the art to understand the technical content of the present disclosure. However, it does not mean that embodiments of the present disclosure may not be applied in another device, system, environment or scene. For example, in an embodiment, an exemplary system architecture in which a method and an apparatus of training a detection model, a method and an apparatus of detecting target image may be applied may include a terminal device. However, the terminal device may achieve the method and the apparatus of training a detection model, the method and the apparatus of detecting target image provided by embodiments of the present disclosure without necessarily interacting with a server.

As shown in FIG. 1, the system architecture 100 according to an embodiment may include terminal devices 101, 102, 103, a network 104 and a server 105. The network 104 is used to provide a medium of a communication link among the terminal devices 101, 102, 103 and the server 105. The network 104 may include various connection types, including a wired and/or wireless communication link and the like.

Users may use the terminal devices 101, 102, 103 to interact with the server 105 through the network 104 to receive or send messages and the like. Various communication client applications, such as knowledge reading applications, web browser applications, search applications, instant messaging tools, email clients and/or social platform software, etc. (exemplary only) may be installed on the terminal devices 101, 102 and 103.

The terminal devices 101, 102, and 103 may be various electronic devices having a display screen and supporting web browsing, including but not limited to smart phones, tablet computers, laptop computers, desktop computers and the like.

The server 105 may be a server providing various services, such as a background management server (exemplary only) providing support for contents browsed by the user using the terminal devices 101, 102, and 103. The background management server may process such as analyze received user requests and other data, and feedback processed results (such as web pages, information, or data, etc., obtained or generated according to the user requests) to the terminal devices.

The server 105 may be a cloud server, also known as a cloud computing server or a cloud host, which is a host product in a cloud computing service system to solve problems of difficult management and weak business expansion in traditional physical hosts and virtual private servers (VPS). The server 105 may also be a server of a distributed system, or a server combined with a blockchain.

It should be noted that the method of training detection model and the method of detecting target image provided by embodiments of the present disclosure may generally be performed by the terminal device 101, 102, or 103. Correspondingly, the apparatus of training the detection model and the apparatus of detecting target image provided by embodiments of the present disclosure may also be provided in the terminal device 101, 102, or 103.

Alternatively, the method of training the detection model and the method of detecting the target image provided by embodiments of the present disclosure may also be generally executed by the server 105. Correspondingly, the apparatus of training the detection model and the apparatus of detecting the target image provided by embodiments of the present disclosure may generally be provided in the server 105. The method of training the detection model and the method of detecting the target image provided by embodiments of the present disclosure may also be executed by a server or server cluster different from the server 105 and capable of communicating with the terminal devices 101, 102, 103 and/or the server 105. Correspondingly, the apparatus of training the detection model and the apparatus of detecting the target image provided by embodiments of the present disclosure may also be provided in a server or server cluster different from the server 105 and capable of communicating with the terminal devices 101, 102, 103 and/or the server 105.

For example, the server 105 may generate an expanded sample image set for a target scene by using a mask image set and an initial sample image set, the mask image set is obtained by parsing a predetermined image set, and a target object in the target scene is interfered by another object or the target object in the target scene is cut off, an image in the predetermined image set include the target object, and the detection model for detecting the target object is trained by using the initial sample image set and the expanded sample image set. Alternatively, a server or server cluster capable of communicating with the terminal devices 101, 102, 103 and/or the server 105 is used to generate the mask image set, and the mask image set and the initial sample image set are used to train the detection model.

For example, the server 105 may acquire the image to be detected, input the image to be detected into the detection model, and obtain a detection result. Alternatively, the server or server cluster capable of communicating with the terminal devices 101, 102, 103 and/or the server 105 may acquire the image to be detected, input the image to be detected into the detection model, and obtain the detection result.

It should be understood that numbers of the terminal devices, the network and the server in FIG. 1 are merely illustrative. There may be any number of terminal devices, networks and servers according to actual requirements.

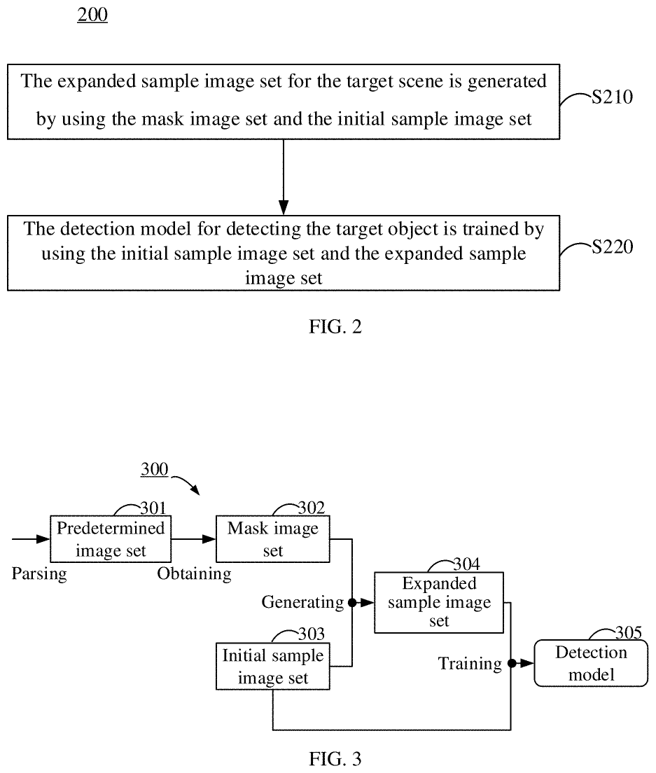

FIG. 2 schematically shows a flowchart of a method of training a detection model according to an embodiment of the present disclosure.

As shown in FIG. 2, the method 200 includes operations S210-S220.

In operation S210, the expanded sample image set for the target scene is generated by using the mask image set and the initial sample image set, wherein the mask image set is acquired by parsing the predetermined image set, and the target object in the target scene is interfered by another object or the target object in the target scene is cut off, and the image in the predetermined image set includes the target object in the target scene or the another object.

In operation S220, the detection model for detecting the target object is trained by using the initial sample image set and the expanded sample image set.

According to an embodiment of the present disclosure, the predetermined image set may refer to a disclosed image set. The predetermined image set may include a plurality of images, each of which may include the target object or another object. The target object may refer to an object to be detected. For example, the target object may include a human body. The another object may refer to an object having an impact on a visual presentation of the target object. For example, the object may cause the target object to be not capable of completely displayed on the image, and there may be missing parts. The another object may include a human body. For example, if the target object includes the human body, the predetermined image set may be a human parsing image set.

According to an embodiment of the present disclosure, a mask image in the mask image set may include the target object or another object. The mask image set may include a plurality of mask images. The initial sample image set may include a plurality of initial sample images. The initial sample set may be partially derived from the predetermined sample image set, or may also be entirely derived from the predetermined sample image set, or may not be derived from the predetermined sample image set at all. The above may be configured according to actual business requirements, which is not limited here.

According to an embodiment of the present disclosure, the target scene may refer to the complicated scene described above, that is, the target scene may refer to a scene in which the target object is difficult to be detected. The target scene may include a scene in which the target object is interfered by another object or a scene in which the target object is cut off.

According to an embodiment of the present disclosure, the scene in which the target object is interfered by another object may include at least one of: a crowded scene and an occlusion scene. The scene in which the target object is cut off may refer to a cutoff scene. The crowded scene may refer to a scene in which a distance between the included target object and an object of the same type as the target object is less than or equal to a first predetermined distance threshold, and the target object and the object of the same type as the target object do not occlude each other. The occlusion scene may refer to a scene in which the distance between the included target object and the object of the same type as the target object is less than or equal to a second predetermined distance threshold and the target object and the object of the same type as the target object occlude each other. The first predetermined distance threshold is greater than the second predetermined distance threshold. In the crowded scene and the occlusion scene, the target object may not be completely displayed on the image due to an influence of another object, while the target object itself is complete. In the cutoff scene, the target object may not be completely displayed on the image since the target object itself is not complete.

According to an embodiment of the present disclosure, the predetermined image set may be acquired, at least one image may be selected from a plurality of images included in the predetermined image set, and each image in the at least one image may be parsed to obtain a mask parameter corresponding to an object in the image, and a mask image corresponding to the image is obtained according to the mask parameter corresponding to the object in the image. Detection box information corresponding to the mask image may be obtained according to the mask image corresponding to the image. Parsing the image to obtain the mask parameter corresponding to the object in the image may include: parsing the image by using a mask function to obtain the mask parameter corresponding to the object in the image. The object in the “object in the image” may include the target object or another object.

According to an embodiment of the present disclosure, for the initial sample images in the initial sample image set, the mask image may be selected from the mask image set, and the initial sample image may be processed by using the mask image to obtain the expanded sample image.

According to an embodiment of the present disclosure, after the expanded sample image is obtained, the detection model may be trained by using the initial sample image set and the expanded sample image set. The detection model is the model used to detect the target object. For example, the detection model may be used to achieve pedestrian detection. The detection model may include a two-stage detection model or a one-stage detection model. The two-stage detection model may include region-convolutional neural network (R-CNN), Fast R-CNN or Faster R-CNN. The one-stage detection model may include YOLO or single shot multibox detector (SSD). The detection model may be selected according to actual business requirements, which is not limited here.

It should be noted that the detection model in an embodiment of the present disclosure is not a detection model for a specific object, and may not reflect a personal information of the specific object.

According to an embodiment of the present disclosure, the expanded sample image set for the target scene is generated by using the mask image set and the initial sample image set, and the mask image set is obtained by using the disclosed predetermined image set, therefore an increase in the number of the sample images for the target scene is achieved without additional acquisition (i.e., the expanded sample image set for the target scene is obtained), thereby reducing an improvement cost. Moreover, since the expanded sample image set is generated by using the mask image set and the initial sample image set rather than using the data augmentation algorithm to process the initial sample image, it is possible to reduce the distortions in some areas of the image caused by the data augmentation algorithm as much as possible, thereby effectively ensuring the image quality of the expanded sample image set (that is, the image quality of the sample image in the target scene). In addition, since the data balancing strategy is implemented, there is no need to modify the disclosed training framework, that is, the operation of performing the generation of the expanded sample image set may be inserted into the disclosed training framework as a module, so the improvement cost may be further reduced. Based on the above contents, on the basis of not increasing the improvement cost as much as possible, since the number of the sample images in the target scene participating in the training of the detection model is increased and the image quality of the sample images in the target scene is effectively ensured, the prediction accuracy of the detection model for the target scene is improved.

The method shown in FIG. 2 will be further described below with reference to FIG. 3 to FIG. 7 in conjunction with specific embodiments.

FIG. 3 schematically shows a schematic diagram of a process of training a detection model according to an embodiment of the present disclosure.

As shown in FIG. 3, in a training process 300, a predetermined image set 301 is acquired, and the predetermined image set 301 is parsed to obtain a mask image set 302, the mask image set 302 and an initial sample image set 303 are used to generate an expanded sample image set 304 for a target scene, and a detection model 305 is trained by using the initial sample image set 303 and the expanded sample image set 304.

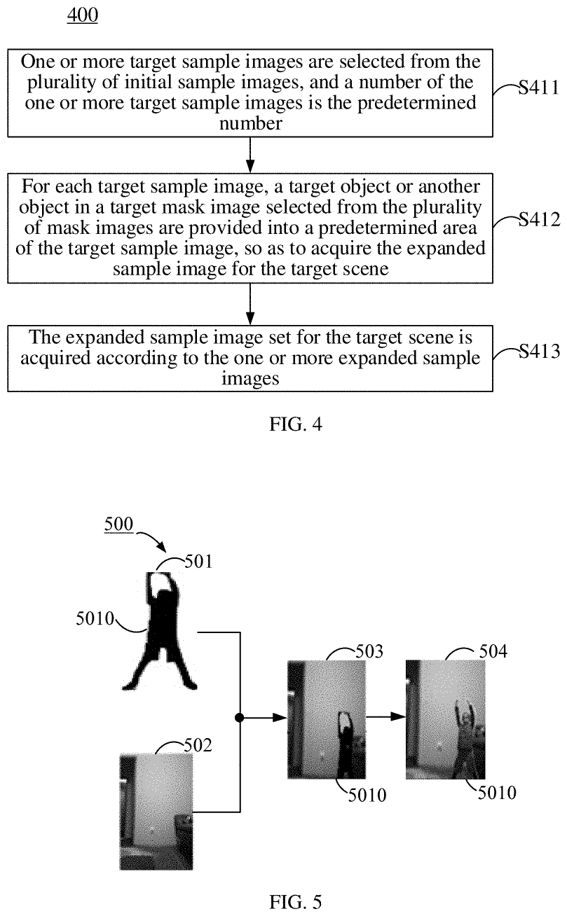

FIG. 4 schematically shows a flowchart of generating an expanded sample image set for a target scene using a mask image set and an initial sample image set according to an embodiment of the present disclosure.

According to an embodiment of the present disclosure, the mask image set includes a plurality of mask images, the initial sample image set includes a plurality of initial sample images, and the expanded sample image set includes one or more expanded sample images, and a number of the one or more expanded sample images is a predetermined number.

As shown in FIG. 4, the method 400 includes operations S411 to S413.

In operation S411, one or more target sample images are selected from the plurality of initial sample images, and a number of the one or more target sample images is the predetermined number.

In operation S412, for each target sample image of the one or more target sample images, a target object or another object in a target mask image selected from the plurality of mask images are provided into a predetermined area of the target sample image, so as to acquire the expanded sample image for the target scene.

In operation S413, the expanded sample image set for the target scene is acquired according to the one or more expanded sample images.

According to an embodiment of the present disclosure, the predetermined number may be configured according to actual business requirements, which is not limited here. For example, the number of the initial sample images is R, and the predetermined number is T. R is greater than or equal to T, T is greater than or equal to 1, and R and T are integers.

According to an embodiment of the present disclosure, the target sample image may refer to an initial sample image selected from the initial sample images and used to participate in generating the expanded sample image. The target mask image may refer to a mask image selected from the mask image set and used to participate in generating the expanded sample image.

According to an embodiment of the present disclosure, the predetermined area may refer to a relevant area of the target sample image. For example, the predetermined area may include a predetermined edge area or a predetermined occlusion area.

According to an embodiment of the present disclosure, in order to obtain an expanded sample image in which the target object is cutoff, a following method may be used, that is, for the target sample image, a target mask image for processing the target sample image may be selected from a plurality of mask images, the target object in the target mask image is provided in the predetermined area of the target sample image so as to obtain the expanded sample image, so that the target object in the expanded sample image is cut off. Since the expanded sample image is generated according to the target mask image and the target sample image, the target object in the target mask image may be represented in the expanded sample image, another object in the target mask image may be represented in the expanded sample image. The difference is that the target object in the expanded sample image is interfered by another object in the expanded sample image or the target object in the expanded sample image is cut off. The target object may refer to an object in the target sample image. The another object may refer to an object in the target mask image of the same type as the target object in the target sample image.

According to an embodiment of the present disclosure, in order to obtain the expanded sample image in which the target object is interfered by another object, the following method may be used, that is, for the target sample image, the target mask image for processing the target sample image may be selected from the plurality of mask images, another object in the target mask image is provided into the predetermined area corresponding to the target object in the target sample image, and the expanded sample image is obtained, so that the target object in the expanded sample image is interfered by another object. Since the expanded sample image is generated according to the target mask image and the target sample image, the another object in the target mask image may be represented in the expanded sample image, the target object in the target sample image may be represented in the expanded sample image. The difference is that the target object in the expanded sample image is interfered by the another object in the expanded sample image.

According to an embodiment of the present disclosure, the target object in the target scene is cut off, the predetermined number includes a first predetermined number, the target sample image includes a first target sample image, the target mask image includes a first target mask image, the expanded sample image set includes a cutoff sample image set, and the cutoff sample image set includes one or more cutoff sample images, and a number of the one or more cutoff sample images is the first predetermined number.

Operation S412 may include the following operations.

According to a first transformation matrix and a coordinate before transformation of a target object in the first target mask image selected from the plurality of mask images, a coordinate after transformation of the target object in the first target mask image is obtained. The coordinate before transformation of the target object in the first target mask image is determined according to a first detection box information corresponding to the target object in the first target mask image. The coordinate after transformation of the target object in the first target mask image is used to provide the target object in the first target mask image into a predetermined edge area of the first target sample image to acquire the cutoff sample image. A target object in the cutoff sample image is cut off.

According to an embodiment of the present disclosure, the target object in the first target mask image has the first detection box information corresponding thereto, and the first detection box information may be used to characterize a location information of the target object in the first target mask image. The coordinate before transformation of the target object in the first target mask image may be determined according to the first detection box information. The predetermined edge area of the first target sample image may characterize an area that does not include an object and is located at an edge of the first target sample image.

According to an embodiment of the present disclosure, in order to obtain the cutoff sample image, the first transformation matrix and the coordinate before transformation of the target object in the first target mask image may be used to obtain the coordinate after transformation of the target object in the first target mask image, that is, the first transformation matrix may be multiplied by the coordinate before transformation of the target object in the first target mask image so as to obtain the coordinate after transformation of the target object in the first target mask image.

According to an embodiment of the present disclosure, after obtaining the coordinate after transformation of the target object in the first target mask image, the target object in the first target mask image is provided into the predetermined edge area of the first target sample image according to the coordinate after transformation of the target object in the first target mask image, so as to obtain the cutoff sample image, and the target object in the cutoff sample image is cut off.

According to an embodiment of the present disclosure, the coordinate after transformation of the target object in the first target mask image may be determined by using the following formula (1).

$$[ \begin{matrix}{x}^{t} \\ {y}^{t} \\ 1\end{matrix} ] = H \times [ \begin{matrix}y \\ x \\ 1\end{matrix} ] \qquad ( 1 )$$

An abscissa before transformation of the target object in the first target mask image is represented by x^{t}, and an ordinate before transformation of the target object in the first target mask image is represented by y^{t}. The abscissa after transformation of the target object in the first target mask image is represented by x, and the ordinate after transformation of the target object in the first target mask image is represented by y.

According to an embodiment of the present disclosure, the above-mentioned method of training the detection model may further include the following operations.

In case where it is determined that an area of the target object in the cutoff sample image is greater than or equal to a predetermined area threshold, it is determined that the cutoff sample image belongs to the cutoff sample image set, and the predetermined area threshold is determined according to an area of the target object in the first target mask image.

According to an embodiment of the present disclosure, in order to ensure an image quality of the cutoff sample image so as to ensure a prediction accuracy of the detection model, it is necessary to make the cutoff sample image in the cutoff sample set participating in the training of the detection model to be a cutoff sample image satisfying a first predetermined condition. The first predetermined condition may include that the area of the target object in the cutoff sample image is greater than or equal to a predetermined area threshold. The predetermined area threshold may be determined according to the area of the target object in the first target mask image. For example, the area of the target object in the first target mask image is S, and the predetermined area threshold may be set to 0.3 S.

FIG. 5 schematically shows a schematic diagram of a process of generating a cutoff sample image according to an embodiment of the present disclosure.

As shown in FIG. 5, in the process 500, a coordinate after transformation of a target object 5010 in a first target mask image 501 is used to provide the target object 5010 in the first target mask image 501 into a predetermined edge area of a first target sample image 502 so as to obtain a cutoff sample image 503, and the cutoff sample image 503 is processed to obtain a processed cutoff sample image 504.

According to an embodiment of the present disclosure, the target object in the target scene is interfered by another object, the predetermined number includes a second predetermined number, the target sample image includes a second target sample image, the target mask image includes a second target mask image, the expanded sample image set includes a first crowded occlusion sample image set, and the first crowded occlusion sample image set includes one or more first crowded occlusion sample images, and a number of the one or more first crowded occlusion sample images is the second predetermined number.

Operation S412 may include the following operations.

According to a second transformation matrix and a coordinate before transformation of another object in the second target mask image selected from the plurality of mask images, a coordinate after transformation of the another object in the second target mask image is acquired. The coordinate before transformation of the another object in the second target mask image is determined according to a second detection box information corresponding to the another object in the second target mask image. The coordinate after transformation of the another object in the second target mask image is used to provide the another object in the second target mask image into a first predetermined occlusion area corresponding to the target object in the second target sample image to acquire the first crowded occlusion sample image. The first predetermined occlusion area is determined according to a third detection box information corresponding to the target object in the second target sample image, and a target object in the first crowded occlusion sample image is interfered by another object in the first crowded occlusion sample image.

According to an embodiment of the present disclosure, the another object in the second target mask image has the second detection box information corresponding thereto, and the second detection box information may be used to characterize a location information of the another object in the second target mask image. The coordinate before transformation of the another object in the second target mask image may be determined according to the second detection box information. The first predetermined occlusion area may be determined according to the third detection box information corresponding to the target object in the second target sample image. For example, a detection box area may be determined according to the third detection box information corresponding to the target object in the second target sample image. The first predetermined occlusion area may be an area corresponding to the detection box area, and the area corresponding to the detection box area may include an area having an intersection with the detection box area.

According to an embodiment of the present disclosure, in order to obtain the first crowded occlusion sample image, the target object in the first crowded occlusion sample image is from the second target sample image, the another object in the first crowded occlusion sample image is from the second target mask image, the second transformation matrix and the coordinate before transformation of the another object in the second target mask image may be used to obtain the coordinate after transformation of the another object in the second target mask image, that is, the second transformation matrix may be multiplied by the coordinate before transformation of the another object in the second target mask image so as to obtain the coordinate after transformation of the another object in the second target mask image.

According to an embodiment of the present disclosure, after obtaining the transformed coordinates of the another object in the second target mask image, the another object in the second target mask image is provided into the first predetermined occlusion area corresponding to the target object in the second target sample image according to the coordinate after transformation of the another object in the second target mask image, so as to obtain the first crowded occlusion sample image.

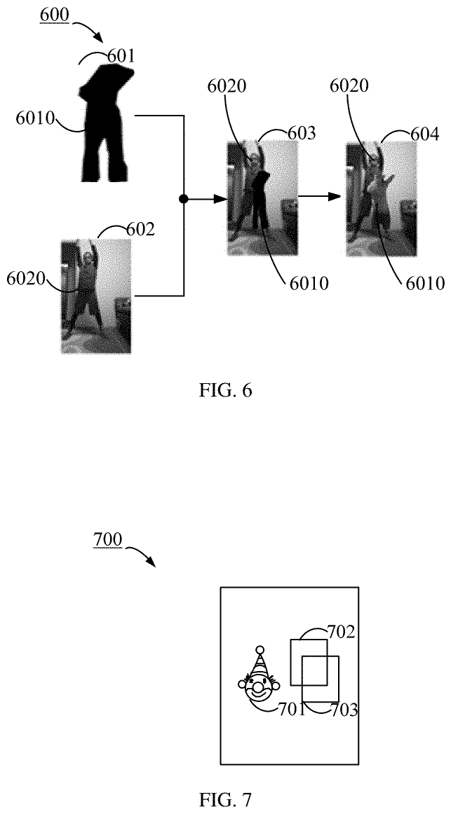

FIG. 6 schematically shows a schematic diagram of a process of generating a first crowded occlusion image according to an embodiment of the present disclosure.

As shown in FIG. 6, in a process 600, a coordinate after transformation of an another object 6010 in a second target mask image 601 is used to provide the another object 6010 in the second target mask image 601 into a first predetermined occlusion area corresponding to a target object 6020 in a second target sample image 602, so as to obtain a first crowded occlusion sample image 603, and the first crowded occlusion sample image 603 is processed to obtain a processed first crowded occlusion sample image 604. The target object 6020 in the first crowded occlusion sample image 604 is occluded by the another object 6010.

According to an embodiment of the present disclosure, the above-mentioned method of training the detection model may further include the following operations.

A first crowded occlusion value is determined according to the second detection box information and the third detection box information, the first crowded occlusion value is used to characterize a degree to which the target object in the first crowded occlusion sample image is interfered by the another object. When the first crowded occlusion value is determined to be greater than or equal to a first predetermined crowded occlusion threshold, it is determined that the first crowded occlusion sample image belongs to the first crowded occlusion sample image set.

According to an embodiment of the present disclosure, in order to ensure the image quality of the first crowded occlusion sample image and to ensure the prediction accuracy of the detection model, the first crowded occlusion sample image in the first crowded occlusion sample image set participating in the training of the detection model should be a first crowded occlusion sample image satisfying a second predetermined condition. The second predetermined condition may include that the first crowded occlusion value is greater than or equal to the first predetermined crowded occlusion threshold. The first predetermined crowded occlusion threshold may be configured according to actual business requirements, which is not limited here.

According to an embodiment of the present disclosure, the second detection box information includes a first coordinate information of a first center point of a first detection box, and the third detection box information includes a second coordinate information of a second center point of a second detection box.

The determining the first crowded occlusion value according to the second detection box information and the third detection box information may include the following operations.

A distance between the first center point and the second center point is determined according to the first coordinate information and the second coordinate information. The first crowded occlusion value is determined according to the distance between the first center point and the second center point.

According to an embodiment of the present disclosure, an inverse of the distance between the first center point and the second center point may be determined as the first crowded occlusion value. The first crowded occlusion value may be determined by using the following formula (2).

crowdegree=\sqrt{(x_{c1}−x_{c2})²+(y_{c1}−y_{c2})²} (2)

wherein crowdegree is used to characterize the first crowded occlusion value, x_{c1} is used to characterize an abscissa of the first center point, y_{c1} is used to characterize an ordinate of the first center point, x_{c2} is used to characterize an abscissa of the second center point, and y_{c2} is used to characterize an ordinate of the second center point.

According to an embodiment of the present disclosure, the target object in the target scene is interfered by another object, the predetermined number includes a third predetermined number, the target sample image includes a third target sample image, the target mask image includes a third target mask image, the expanded sample image set includes a second crowded occlusion sample image set, the second crowded occlusion sample image set includes one or more second crowded occlusion sample images, and a number of the one or more second crowded occlusion sample images is the third predetermined number.

Operation S412 may include the following operations.

A coordinate after transformation of the target object in each of at least two third target mask images selected from the plurality of mask images is acquired according to a third transformation matrix and a coordinate before transformation of a target object in each of the at least two third target mask images. The coordinate before transformation of the target object in each third target mask image is determined according to a fourth detection box information corresponding to the target object in the third target mask image. The coordinate after transformation of the target object in each of the at least two third target mask images is used to provide the target object in each of the at least two third target mask images into a second predetermined occlusion area of the third target sample image so as to acquire the second crowded occlusion sample image. The second predetermined occlusion area is determined according to a fifth detection box information corresponding to the third target sample image, and every two adjacent target objects in the second crowded occlusion sample image interfere with each other.

According to an embodiment of the present disclosure, in order to obtain the second crowded occlusion sample image, two adjacent target objects in the second crowded occlusion sample image may be from the third target mask images. If one of the two adjacent target objects is used as the target object, then the other one of the two adjacent target objects may be used as the another object, and the coordinate after transformation of the target object in the third target mask image may be obtained according to the third transformation matrix and the coordinate before transformation of the target object in each third target mask image, that is, the third transformation matrix may be multiplied by the coordinate before transformation of the target object in the third target mask image to obtain the coordinate after transformation of the target object in the third target mask image.

According to an embodiment of the present disclosure, after obtaining the coordinate after transformation of the target object in the third target mask image, the target object in the third target mask image may be provided into the second predetermined occlusion area corresponding to the third target sample image according to the coordinate after transformation of the target object in the third target mask image, and the second crowded occlusion sample image is obtained.

According to an embodiment of the present disclosure, the second predetermined occlusion area includes a plurality of predetermined occlusion subareas.

Using the coordinate after transformation of the target object in each of the at least two third target mask images to provide the target object in each of the at least two third target mask images into the second predetermined occlusion area corresponding to the third target sample image so as to obtain the second crowded occlusion sample image may include the following operations.

One third target mask image is selected from the at least two third target mask images to be determined as the current third target mask image. The coordinate after transformation of the target object in the current third target mask image is used to provide the target object in the current third target mask image into a predetermined occlusion subarea of the third target sample image corresponding to the current third target mask image. A following third target mask image corresponding to the current third target mask image is determined. The coordinate after transformation of the target object in the following third target mask image is used to provide the target object in the following third target mask image into a predetermined occlusion subarea of the third target sample image corresponding to the following third target mask image. The predetermined occlusion subarea of the third target sample image corresponding to the following third target mask image is determined according to the predetermined occlusion subarea of the third target sample image corresponding to the current third target mask image. The operation of providing the target object in the third target mask image into the predetermined occlusion subarea of the third target sample image corresponding to the third target mask image is repeated until the target object in each third target mask image is provided. The third target sample image obtained when the target object in each third target mask image is provided is determined as the second crowded occlusion sample image.

According to an embodiment of the present disclosure, the target object of each of the at least two third target mask images may be provided into the predetermined subarea corresponding to the third target sample image in a predetermined sequence.

For example, one third target mask image may be further selected from the selected at least two third target mask images to be determined as the current third target mask image, the target image in the current third target mask image is provided into the predetermined subarea corresponding to the third target sample image, and the providing of the target object in the current third target mask image is completed. The predetermined subarea corresponding to the third target sample image may refer to an area having no intersection with the detection box corresponding to the target object in the third target sample image.

After completing the providing of the target object in the current third target mask image, one third target mask image may be selected from the remaining third target mask images except the current third target mask image to be determined as the following third target mask image corresponding to the current third target mask image, and the target object in the following third target mask image is provided into the predetermined occlusion subarea of the third target sample image corresponding to the following third target mask image so as to complete the providing of the target object in the following third target mask image.

According to an embodiment of the present disclosure, the predetermined occlusion subarea of the third target sample image corresponding to the following third target mask image may be determined according to the predetermined occlusion subarea of the third target sample image corresponding to the current third target mask image, that is, an area having intersection with an area occupied by the target object in the current third target mask image may be determined as the predetermined occlusion subarea of the third target sample image corresponding to the following third target mask image. That is, the target object in the current third target mask image and the target object in the following third target mask image are ensured to be interfering with each other as much as possible.

According to an embodiment of the present disclosure, the operation of providing the target object in the selected third target mask image into the predetermined occlusion subarea of the third target sample image corresponding to the third target mask image may be repeated until the target object in each third target mask image is provided.

FIG. 7 schematically shows a schematic diagram of a second occlusion sample image according to an embodiment of the present disclosure.

As shown in FIG. 7, 701 in a second occlusion sample image 700 is used to characterize a target object in a second target sample image, and 702 and 703 are used to characterize target objects in second target mask images. In the second occlusion sample image 700, the first target object 702 is occluded by the second target object 703.

According to an embodiment of the present disclosure, the above-mentioned method of training the detection model may include the following operations.

According to a pixel information of the target object corresponding to each of at least two predetermined occlusion subareas, at least one second crowded occlusion value is determined. Each second crowded occlusion value is used to characterize a degree of a mutual interference between two adjacent target objects in the second crowded occlusion sample image. When the at least one second crowded occlusion value meets a predetermined crowded occlusion condition, it is determined that the second crowded occlusion sample image belongs to the second crowded occlusion sample image set.

According to an embodiment of the present disclosure, in order to ensure the image quality of the second crowded occlusion sample image so as to ensure the prediction accuracy of the detection model, the second crowded occlusion sample image in the second crowded occlusion sample image set participating in the training of the detection model should be a second crowded occlusion sample image satisfying the predetermined crowded occlusion condition.

According to an embodiment of the present disclosure, the pixel information of the target object corresponding to each predetermined occlusion subarea may include a number of pixels, and the number of pixels may refer to a number of the pixels occupied by the target object in the predetermined occlusion subarea corresponding to the target object, that is, the number of the pixels of the target object included in the predetermined occlusion subarea corresponding to the target object.

According to an embodiment of the present disclosure, the second crowded occlusion value corresponding to each two adjacent target objects may be determined according to the pixel information of the two adjacent target objects, thereby obtaining at least one second crowded occlusion value. It is determined whether the at least one second crowded occlusion value meets the predetermined crowded occlusion condition. If the at least one second crowded occlusion value meets the predetermined crowded occlusion condition, then it is determined that the second crowded occlusion sample image belongs to the second crowded occlusion sample image set.

According to an embodiment of the present disclosure, determining the at least one second crowded occlusion value according to the pixel information of the target object corresponding to each of the at least two predetermined occlusion subareas may include the following operations.

At least one first pixel point number is determined, and each first pixel point number is used to characterize the number of pixel points included in an intersection area occupied by two adjacent target objects provided in the second crowded occlusion sample image. At least one second pixel point number is determined, and each second pixel point number is used to characterize the number of pixel points included in a union area occupied by two adjacent target objects provided in the second crowded occlusion sample image. For every two adjacent target objects, a ratio between the first pixel point number and the second pixel point number is determined. The ratio is determined as the second crowded occlusion value.

According to an embodiment of the present disclosure, for every two adjacent target objects, the intersection area of the two adjacent target objects in the second crowded occlusion sample image is determined, the number of the pixels included in the intersection area is determined, and the number of the pixels included in the intersection area is determined as the first pixel point number. The union area of the two adjacent target objects in the second crowded occlusion sample image is determined, the number of the pixels included in the union area is determined, and the number of the pixels included in the union area is determined as the second pixel point number. The ratio of the first pixel point number to the second pixel point number corresponding to the two adjacent target objects is determined as the second crowded occlusion value.

According to an embodiment of the present disclosure, the second crowded occlusion value may be determined by using the following formula (3).

$$occlu\_degree = \frac{{M}_{{s}_{i}} ⋂ {M}_{{s}_{i + 1}}}{{M}_{{s}_{i}} ⋃ {M}_{{s}_{i + 1}}} \qquad ( 3 )$$

wherein occlu_degree is used to characterize the second crowded occlusion value. Mₛ_{ᵢ}∩Mₛ_{ᵢ₊₁} is used to characterize the number of pixels included in the intersection area occupied by the iₜₕ target object and the i+1ₜₕ target object in the second crowded occlusion sample image. Mₛ_{ᵢ} ∪Mₛ_{ᵢ₊₁} is used to characterize the number of pixels included in the union area occupied by the iₜₕ target object and the i+1ₜₕ target object in the second crowded occlusion sample image. i={1, 2, . . . , U−1, U} U is used to characterize the number of the second target mask image, and U is an integer greater than or equal to 2.

According to an embodiment of the present disclosure, when it is determined that the at least one second crowded occlusion value meets the predetermined crowded occlusion condition, determining that the second crowded occlusion sample image belongs to the second crowded occlusion sample image set may include the following operations.

For each of the at least one second crowded occlusion value, when it is determined that the second crowded occlusion value is greater than or equal to a second predetermined crowded occlusion threshold, the second crowded occlusion value is determined as a target crowded occlusion value. If the number of the target crowded occlusion values is greater than or equal to a predetermined number threshold, then it is determined that the second crowded occlusion sample image belongs to the second crowded occlusion sample image set.

According to an embodiment of the present disclosure, the second predetermined crowded occlusion threshold may be configured according to actual business requirements, which is not limited here. The predetermined number threshold may be configured according to actual business requirements, which is not limited here. The second crowded occlusion value greater than or equal to the second predetermined crowded occlusion threshold may be determined as the target crowded occlusion value.

According to an embodiment of the present disclosure, it is determined whether the number of the target crowded occlusion values is greater than or equal to the predetermined number threshold. If the number of the target crowded occlusion values is greater than or equal to the predetermined number threshold, then it is determined that the second crowded occlusion sample belongs to the second crowded occlusion sample image set.

According to an embodiment of the present disclosure, the initial sample image set includes at least one of: an initial sample image set including the target object and a background, and an initial sample image set including only the background.

According to an embodiment of the present disclosure, if the number of initial sample images included in the initial sample image set does not satisfy a model training condition, the expanded sample image set may also be generated by using the initial sample image set including only the background.

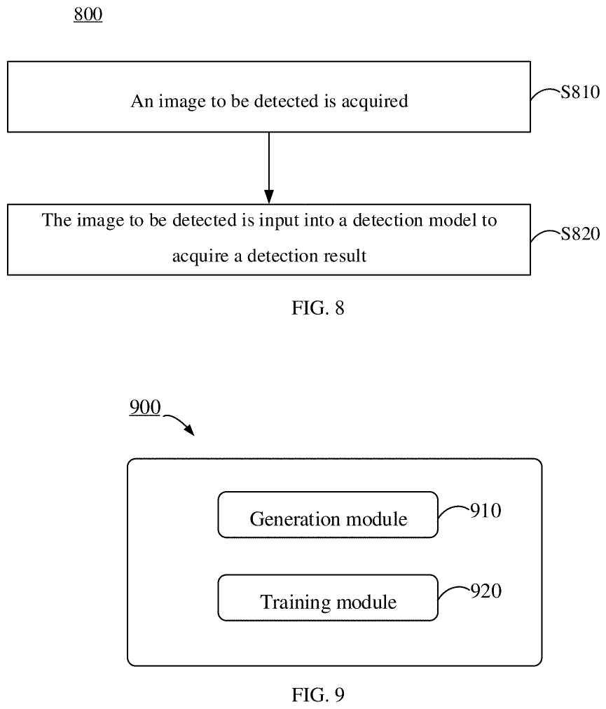

FIG. 8 schematically shows a flowchart of a method of detecting a target image according to an embodiment of the present disclosure.

As shown in FIG. 8, a method 800 includes operations S810-S820.

In operation S810, an image to be detected is acquired.

In operation S820, the image to be detected is input into a detection model to acquire a detection result. The detection model is trained by using the method of training a detection model according to embodiments of the present disclosure.

According to embodiments of the present disclosure, the detection result is obtained by inputting the image to be detected into the detection model, and the detection model is trained by using the method of training a detection model according to embodiments of the present disclosure. The expanded sample image set for the target scene is generated by using the mask image set and the initial sample image set, and the mask image set is obtained by using the disclosed predetermined image set, thus the increase of the number of the sample images for the target scene may be achieved (i.e., the expanded sample image set for the target scene is obtained) without additional acquisition, thereby reducing the improvement cost. Moreover, since the expanded sample image set is generated by using the mask image set and the initial sample image set, rather than using the data augmentation algorithm to process the initial sample images, it is possible to reduce the distortions in some areas of the image caused by the data augmentation algorithm as much as possible, effectively ensuring the image quality of the expanded sample image set (that is, the image quality of the sample images for the target scene). In addition, since the data balancing strategy is implemented, there is no need to modify the disclosed training framework, that is, the operation of performing the generation of the expanded sample image set may be inserted into the disclosed training framework as the module, so the improvement cost may be further reduced. Based on the above contents, on the basis of not increasing the improvement cost as much as possible, since the number of sample images in the target scene participating in the training of the detection model is increased and the image quality of the sample images in the target scene is effectively ensured, therefore, the prediction accuracy of the detection model for the target scene is therefore improved.

FIG. 9 schematically shows a block diagram of an apparatus of training a detection model according to an embodiment of the present disclosure.

As shown in FIG. 9, a device 900 of training a detection model may include a generation module 910 and a training module 920.

The generation module 910 is used to generate an expanded sample image set for a target scene by using a mask image set and an initial sample image set. The mask image set is acquired by parsing a predetermined image set, a target object in the target scene is interfered by another object or the target object in the target scene is cut off, and an image in the predetermined image set includes the target object in the target scene or the another object.

The training module 920 is used to train a detection model, by using the initial sample image set and the expanded sample image set, for detecting the target object.

According to an embodiment of the present disclosure, the mask image set includes a plurality of mask images, the initial sample image set includes a plurality of initial sample images, the expanded sample image set includes one or more expanded sample images, and a number of the one or more expanded sample images is a predetermined number.

The generating module may include a selection sub-module, a provision sub-module, and an obtaining sub-module.

The selection sub-module is used to select one or more target sample images from the plurality of initial sample images, wherein a number of the one or more target sample images is the predetermined number.

The provision sub-module is used to provide, for each target sample image of the one or more target sample images, a target object or another object in a target mask image selected from the plurality of mask images into a predetermined area of the target sample image, so as to acquire the expanded sample image for the target scene.

The obtaining sub-module is used to acquire the expanded sample image set for the target scene according to the one or more expanded sample images.

According to an embodiment of the present disclosure, the target object in the target scene is cut off, the predetermined number includes a first predetermined number, the target sample image includes a first target sample image, the target mask image includes a first target mask image, the expanded sample image set includes a cutoff sample image set, and the cutoff sample image set includes one or more cutoff sample images, and a number of the one or more cutoff sample images is the first predetermined number.

The provision sub-module may include a first obtaining unit and a second obtaining unit.

The first obtaining unit is used to acquire, according to a first transformation matrix and a coordinate before transformation of a target object in the first target mask image selected from the plurality of mask images, a coordinate after transformation of the target object in the first target mask image. The coordinate before transformation of the target object in the first target mask image is determined according to a first detection box information corresponding to the target object in the first target mask image.

The second obtaining unit is used to provide the target object in the first target mask image into a predetermined edge area of the first target sample image by using the coordinate after transformation of the target object in the first target mask image so as to acquire the cutoff sample image. A target object in the cutoff sample image is cut off.

According to an embodiment of the present disclosure, the above-mentioned apparatus 900 of training a detection model may further include a first determining module.

The first determining module is used to determine that the cutoff sample image belongs to the cutoff sample image set in case where it is determined that an area of the target object in the cutoff sample image is greater than or equal to a predetermined area threshold. The predetermined area threshold is determined according to an area of the target object in the first target mask image.

According to an embodiment of the present disclosure, the target object in the target scene is interfered by another object, the predetermined number includes a second predetermined number, the target sample image includes a second target sample image, the target mask image includes a second target mask image, the expanded sample image set includes a first crowded occlusion sample image set, and the first crowded occlusion sample image set includes one or more first crowded occlusion sample images, and a number of the one or more first crowded occlusion sample images is the second predetermined number.

The provision sub-module may include a third obtaining unit and a fourth obtaining unit.

The third obtaining unit is used to acquire, according to a second transformation matrix and a coordinate before transformation of another object in the second target mask image selected from the plurality of mask images, a coordinate after transformation of the another object in a second target mask image. The coordinate before transformation of the another object in the second target mask image is determined according to a second detection box information corresponding to the another object in the second target mask image.

The fourth obtaining unit is used to provide the another object in the second target mask image into a first predetermined occlusion area corresponding to a target object in the second target sample image by using the coordinate after transformation of the another object in the second target mask image so as to acquire the first crowded occlusion sample image. The first predetermined occlusion area is determined according to a third detection box information corresponding to the target object in the second target sample image, and a target object in the first crowded occlusion sample image is interfered by another object in the first crowded occlusion sample image.

According to an embodiment of the present disclosure, the above-mentioned apparatus 900 of training a detection model may further include a second determining module and a third determining module.

The second determining module is used to determine a first crowded occlusion value according to the second detection box information and the third detection box information. The first crowded occlusion value is used to characterize a degree to which the target object in the first crowded occlusion sample image is interfered by the another object.

The third determining module is used to determine that the first crowded occlusion sample image belongs to the first crowded occlusion sample image set when it is determined that the first crowded occlusion value is greater than or equal to a first predetermined crowded occlusion threshold.

According to an embodiment of the present disclosure, the second detection box information includes a first coordinate information of a first center point of the first detection box, and the third detection box information includes a second coordinate information of a second center point of the second detection box.

The second determining module may include a first determining sub-module and a second determining sub-module.

The first determining sub-module is used to determine a distance between the first center point and the second center point according to the first coordinate information and the second coordinate information.

The second determining sub-module is used to determine the first crowded occlusion value according to the distance between the first center point and the second center point.

According to an embodiment of the present disclosure, the target object in the target scene is interfered by the another object, the predetermined number includes a third predetermined number, the target sample image includes a third target sample image, the target mask image includes a third target mask image, the expanded sample image set includes a second crowded occlusion sample image set, and the second crowded occlusion sample image set includes one or more second crowded occlusion sample images, and a number of the one or more second crowded occlusion sample images is the third predetermined number.

The provision sub-module may include a fifth obtaining unit and a sixth obtaining unit.

The fifth obtaining unit is used to acquiring, according to a third transformation matrix and a coordinate before transformation of a target object in each third target mask image of at least two third target mask images selected from the plurality of mask images, a coordinate after transformation of the target object in each of at least two third target mask images. The coordinate before transformation of the target object in each third target mask image is determined according to a fourth detection box information corresponding to the target object in the third target mask image.

The sixth obtaining unit is used to provide the target object in each of the at least two third target mask images into a second predetermined occlusion area of the third target sample image by using the coordinate after transformation of the target object in each of the at least two third target mask images, so as to acquire the second crowded occlusion sample image. The second predetermined occlusion area is determined according to a fifth detection box information corresponding to the third target sample image, and every two adjacent target objects in the second crowded occlusion sample image interfere with each other.

According to an embodiment of the present disclosure, the second predetermined occlusion area includes a plurality of predetermined occlusion subareas.

The sixth obtaining unit may include a first determining subunit, a first provision subunit, a second determining subunit, a second provision subunit, a repetitive performing subunit, and a third determining subunit.

The first determining subunit is used to determine one third target mask image selected from the at least two third target mask images as a current third target mask image.

The first provision subunit is used to provide the target object in the current third target mask image into a predetermined occlusion subarea of the third target sample image corresponding to the current third target mask image by using the coordinate after transformation of the target object in the current third target mask image.

The second determining subunit is used to determine a following third target mask image corresponding to the current third target mask image.

The second provision subunit is used to provide the target object in the following third target mask image into a predetermined occlusion subarea of the third target sample image corresponding to the following third target mask image by using the coordinate after transformation of the target object in the following third target mask image. The predetermined occlusion subarea of the third target sample image corresponding to the following third target mask image is determined according to the predetermined occlusion subarea of the third target sample image corresponding to the current third target mask image.

The repetitive performing subunit is used to repeat the operation of providing the target object in the third target mask image into the predetermined occlusion subarea of the third target sample image corresponding to the third target mask image, until the target object in each third target mask image is provided.

The third determination subunit is used to determine the third target sample image obtained when the target object in each third target mask image is provided as the second crowded occlusion sample image.

According to an embodiment of the present disclosure, the above-mentioned apparatus 900 of training a detection model may further include a fourth determining module and a fifth determining module.

The fourth determining module is used to determine at least one second crowded occlusion value according to a pixel information of the target object corresponding to each of at least two predetermined occlusion subareas. Each second crowded occlusion value is used to characterize a degree of an interference between two adjacent target objects in the second crowded occlusion sample image.

The fifth determining module is used to determine that the second crowded occlusion sample image belongs to the second crowded occlusion sample image set when it is determined that the at least one second crowded occlusion value meets a predetermined crowded occlusion condition.

According to an embodiment of the present disclosure, the fourth determining module may include a third determining sub-module, a fourth determining sub-module, a fifth determining sub-module, and a sixth determining sub-module.

The third determining sub-module is used to determine at least one first pixel point number. Each first pixel point number is used to characterize a number of pixel points included in an intersection area occupied by two adjacent target objects provided in the second crowded occlusion sample image.

The fourth determining sub-module is used to determine at least one second pixel point number. Each second pixel point number is used to characterize a number of pixel points included in a union area occupied by two adjacent target objects provided in the second crowded occlusion sample image.

The fifth determining sub-module is used to determine a ratio of the first pixel point number to the second pixel point number for every two adjacent target objects.

The sixth determining sub-module is used to determine the ratio as the second crowded occlusion value.

According to an embodiment of the present disclosure, the fifth determining module may include a seventh determining sub-module and an eighth determining sub-module.

The seventh determining sub-module is used to determine, for each of the at least one second crowded occlusion value, the second crowded occlusion value as a target crowded occlusion value when it is determined that the second crowded occlusion value is greater than or equal to a second predetermined crowded occlusion threshold.

The eighth determining sub-module is used to determine that the second crowded occlusion sample image belongs to the second crowded occlusion sample image set when it is determined that a number of the target crowded occlusion values is greater than or equal to a predetermined number threshold.

According to an embodiment of the present disclosure, the initial sample image set includes at least one of: an initial sample image set including the target object and a background, and an initial sample image set including only the background.

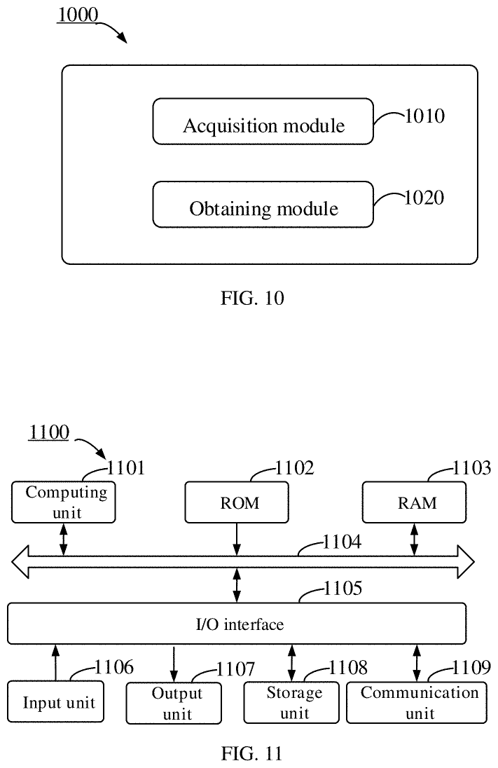

FIG. 10 schematically shows a block diagram of an apparatus of detecting a target image according to an embodiment of the present disclosure.

As shown in FIG. 10, an apparatus 1000 of detecting a target image may include an acquisition module 1010 and an obtaining module 1020.

The acquisition module 1010 is used to acquire an image to be detected.

The obtaining module 1020 is used to input the image to be detected into a detection model to acquire a detection result. The detection model is trained by using the apparatus of training a detection model according to an embodiment of the present disclosure.

In the technical solution of the present disclosure, the collection, storage, use, processing, transmission, provision, disclosure, and application of the user's personal information involved are all in compliance with relevant laws and regulations, take essential confidentiality measures, and do not violate public order and good customs.

In the technical solution of the present disclosure, authorization or consent is obtained from the user before the user's personal information is obtained or collected.

According to an embodiment of the present disclosure, the present disclosure further provides an electronic device, a readable storage medium, and a computer program product.

According to an embodiment of the present disclosure, there is provided an electronic device, including: at least one processor; and a memory communicatively connected with the at least one processor; the memory stores instructions executable by the at least one processor, and the instructions, when executed by the at least one processor, cause the at least one processor to implement the method as described above.

According to an embodiment of the present disclosure, there is provided a non-transitory computer-readable storage medium stored with computer instructions, and the computer instructions are used to cause a computer to implement the method described above.

According to an embodiment of the present disclosure, there is provided a computer program product including computer programs, and the computer programs, when executed by a processor, implement the method described above.

FIG. 11 shows a schematic block diagram of an electronic device suitable for the method of training a detection model and the method of detecting a target image according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 11, the electronic device 1100 may include a computing unit 1101, which may perform various appropriate actions and processing based on a computer program stored in a read-only memory (ROM) 1102 or a computer program loaded from a storage unit 1108 into a random access memory (RAM) 1103. Various programs and data required for the operation of the electronic device 1100 may be stored in the RAM 1103. The computing unit 1101, the ROM 1102 and the RAM 1103 are connected to each other through a bus 1104. An input/output (I/O) interface 1105 is also connected to the bus 1104.

Various components in the electronic device 1100, including an input unit 1106 such as a keyboard, a mouse, etc., an output unit 1107 such as various types of displays, speakers, etc., a storage unit 1108 such as a magnetic disk, an optical disk, etc., and a communication unit 1109 such as a network card, a modem, a wireless communication transceiver, etc., are connected to the I/O interface 1105. The communication unit 1109 allows the electronic device 1100 to exchange information/data with other devices through a computer network such as the Internet and/or various telecommunication networks.

The computing unit 1101 may be various general-purpose and/or special-purpose processing components with processing and computing capabilities. Some examples of the computing unit 1101 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 1101 may perform the various methods and processing described above, such as the method of training a detection model or the method of detecting a target image. For example, in some embodiments, the method of training a detection model or the method of detecting a target image may be implemented as a computer software program that is tangibly contained on a machine-readable medium, such as a storage unit 1108. In some embodiments, part or all of a computer program may be loaded and/or installed on the electronic device 1100 via the ROM 1102 and/or the communication unit 1109. When the computer program is loaded into the RAM 1103 and executed by the computing unit 1101, one or more steps of the method of training a detection model or the method of detecting a target image described above may be performed. Alternatively, in other embodiments, the computing unit 1101 may be configured to perform the method of training a detection model or the method of detecting a target image in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, as a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, and may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of training a detection model, the method comprising:
generating an expanded sample image set for a target scene by using a mask image set and an initial sample image set, wherein the mask image set is acquired by parsing a predetermined image set, a target object in the target scene is interfered by another object or the target object in the target scene is cut off, and an image in the predetermined image set comprises the target object in the target scene or the another object; and
training, by using the initial sample image set and the expanded sample image set, a detection model for detecting the target object.

2. The method according to claim 1, wherein the mask image set comprises a plurality of mask images, the initial sample image set comprises a plurality of initial sample images, and the expanded sample image set comprises one or more expanded sample images, a number of the one or more expanded sample images is a predetermined number; and
wherein the generating an expanded sample image set for a target scene by using a mask image set and an initial sample image set comprises:
selecting one or more target sample images from the plurality of initial sample images, wherein a number of the one or more target sample images is the predetermined number;
providing, for each target sample image of the one or more target sample images, a target object or another object in a target mask image selected from the plurality of mask images into a predetermined area of the target sample image, so as to acquire the expanded sample image for the target scene; and
acquiring the expanded sample image set for the target scene according to the one or more expanded sample images.

3. The method according to claim 2, wherein the target object in the target scene is cut off, the predetermined number comprises a first predetermined number, the target sample image comprises a first target sample image, the target mask image comprises a first target mask image, the expanded sample image set comprises a cutoff sample image set, the cutoff sample image set comprises one or more cutoff sample images, and a number of the one or more cutoff sample images is the first predetermined number; and
wherein the providing the target object or another object comprises:
acquiring, according to a first transformation matrix and a coordinate before transformation of a target object in the first target mask image selected from the plurality of mask images, a coordinate after transformation of the target object in the first target mask image, wherein the coordinate before transformation of the target object in the first target mask image is determined according to a first detection box information corresponding to the target object in the first target mask image; and
providing the target object in the first target mask image into a predetermined edge area of the first target sample image by using the coordinate after transformation of the target object in the first target mask image, so as to acquire the cutoff sample image, wherein a target object in the cutoff sample image is cut off.

4. The method according to claim 3, further comprising determining, in response to determining an area of the target object in the cutoff sample image being greater than or equal to a predetermined area threshold, that the cutoff sample image belongs to the cutoff sample image set, wherein the predetermined area threshold is determined according to an area of the target object in the first target mask image.

5. The method according to claim 2, wherein the target object in the target scene is interfered by the another object, the predetermined number comprises a second predetermined number, the target sample image comprises a second target sample image, the target mask image comprises a second target mask image, the expanded sample image set comprises a first crowded occlusion sample image set, the first crowded occlusion sample image set comprises one or more first crowded occlusion sample images, and a number of the one or more first crowded occlusion sample images is the second predetermined number; and
wherein the providing the target object or another object comprises:
acquiring, according to a second transformation matrix and a coordinate before transformation of another object in the second target mask image selected from the plurality of mask images, a coordinate after transformation of the another object in the second target mask image, wherein the coordinate before transformation of the another object in the second target mask image is determined according to a second detection box information corresponding to the another object in the second target mask image; and
providing the another object in the second target mask image into a first predetermined occlusion area corresponding to a target object in the second target sample image by using the coordinate after transformation of the another object in the second target mask image, so as to acquire the first crowded occlusion sample image, wherein the first predetermined occlusion area is determined according to a third detection box information corresponding to the target object in the second target sample image, and a target object in the first crowded occlusion sample image is interfered by another object in the first crowded occlusion sample image.

6. The method according to claim 5, further comprising:
determining a first crowded occlusion value according to the second detection box information and the third detection box information, wherein the first crowded occlusion value is configured to characterize a degree of the target object in the first crowded occlusion sample image interfered by the another object in the first crowded occlusion sample image; and
determining, in response to determining the first crowded occlusion value being greater than or equal to a first predetermined crowded occlusion threshold, that the first crowded occlusion sample image belongs to the first crowded occlusion sample image set.

7. The method according to claim 6, wherein the second detection box information comprises a first coordinate information of a first center point of a first detection box, and the third detection box information comprises a second coordinate information of a second center point of a second detection box; and
wherein the determining a first crowded occlusion value according to the second detection box information and the third detection box information comprises:
determining a distance between the first center point and the second center point according to the first coordinate information and the second coordinate information; and
determining the first crowded occlusion value according to the distance between the first center point and the second center point.

8. The method according to claim 2, wherein the target object in the target scene is interfered by the another object, the predetermined number comprises a third predetermined number, the target sample image comprises a third target sample image, the target mask image comprises a third target mask image, the expanded sample image set comprises a second crowded occlusion sample image set, the second crowded occlusion sample image set comprises one or more second crowded occlusion sample images, and a number of the one or more second crowded occlusion sample images is the third predetermined number; and
wherein the providing the target object or another object comprises:
acquiring, according to a third transformation matrix and a coordinate before transformation of a target object in each third target mask image of at least two third target mask images selected from the plurality of mask images, a coordinate after transformation of the target object in each third target mask image of the at least two third target mask images, wherein the coordinate before transformation of the target object in each third target mask image is determined according to a fourth detection box information corresponding to the target object in the third target mask image; and
providing the target object in each third target mask image of the at least two third target mask images into a second predetermined occlusion area of the third target sample image by using the coordinate after transformation of the target object in each third target mask image of the at least two third target mask images, so as to acquire the second crowded occlusion sample image, wherein the second predetermined occlusion area is determined according to a fifth detection box information corresponding to the third target sample image, and every two adjacent target objects in the second crowded occlusion sample image are interfered with each other.

9. The method according to claim 8, wherein the second predetermined occlusion area comprises a plurality of predetermined occlusion subareas; and
wherein the providing the target object in each third target mask image comprises:
selecting one third target mask image of the at least two third target mask images as a current third target mask image;
providing the target object in the current third target mask image into a predetermined occlusion subarea of the third target sample image corresponding to the current third target mask image by using the coordinate after transformation of the target object in the current third target mask image;
determining a following third target mask image corresponding to the current third target mask image;
providing the target object in the following third target mask image into a predetermined occlusion subarea of the third target sample image corresponding to the following third target mask image by using the coordinate after transformation of the target object in the following third target mask image, wherein the predetermined occlusion subarea of the third target sample image corresponding to the following third target mask image is determined according to the predetermined occlusion subarea of the third target sample image corresponding to the current third target mask image;
repeating the operation of providing the target object in the third target mask image into the predetermined occlusion subarea of the third target sample image corresponding to the third target mask image, until the target object in each third target mask image is provided; and
determining the third target sample image as the second crowded occlusion sample image, in case the target object in each third target mask image is provided.

10. The method according to claim 9, further comprising:
determining at least one second crowded occlusion value according to a pixel information of the target object corresponding to each predetermined occlusion subarea of at least two predetermined occlusion subareas, wherein each second crowded occlusion value is configured to characterize a degree of an interference between two adjacent target objects in the second crowded occlusion sample image; and
determining, in response to the at least one second crowded occlusion value meeting a predetermined crowded occlusion condition, that the second crowded occlusion sample image belongs to the second crowded occlusion sample image set.

11. The method according to claim 10, wherein the determining the at least one second crowded occlusion value comprises:
determining at least one first pixel point number, wherein each first pixel point number is configured to characterize a number of pixel points in an intersection area occupied by two adjacent target objects provided in the second crowded occlusion sample image;
determining at least one second pixel point number, wherein each second pixel point number is configured to characterize a number of pixel points in a union area occupied by two adjacent target objects provided in the second crowded occlusion sample image;
determining a ratio of the first pixel point number to the second pixel point number for every two adjacent target objects; and
determining the ratio as the second crowded occlusion value.

12. The method according to claim 11, wherein the determining that the second crowded occlusion sample image belongs to the second crowded occlusion sample image set comprises:
determining, for each second crowded occlusion value of the at least one second crowded occlusion value, the second crowded occlusion value as a target crowded occlusion value in response to determining that the second crowded occlusion value is greater than or equal to a second predetermined crowded occlusion threshold; and
determining that the second crowded occlusion sample image belongs to the second crowded occlusion sample image set in response to determining a number of the target crowded occlusion values being greater than or equal to a predetermined number threshold.

13. The method according to claim 1, wherein the initial sample image set comprises an initial sample image set comprising the target object and a background or an initial sample image set comprising only the background.

14. The method according to claim 2, wherein the initial sample image set comprises an initial sample image set comprising the target object and a background or an initial sample image set comprising only the background.

15. The method according to claim 3, wherein the initial sample image set comprises an initial sample image set comprising the target object and a background or an initial sample image set comprising only the background.

16. A method of detecting a target image, the method comprising:
acquiring an image to be detected; and
inputting the image to be detected into a detection model to acquire a detection result, wherein the detection model is trained by using the method according to claim 1.

17. An electronic device, comprising:
at least one processor; and
a memory communicatively connected with the at least one processor, wherein the memory stores instructions executable by the at least one processor, and the instructions, when executed by the at least one processor, cause the at least one processor to at least:
generate an expanded sample image set for a target scene by using a mask image set and an initial sample image set, wherein the mask image set is acquired by parsing a predetermined image set, a target object in the target scene is interfered by another object or the target object in the target scene is cut off, and an image in the predetermined image set comprises the target object in the target scene or the another object; and
train a detection model, by using the initial sample image set and the expanded sample image set, for detecting the target object.

18. An electronic device, comprising:
at least one processor; and
a memory communicatively connected with the at least one processor, wherein the memory stores instructions executable by the at least one processor, and the instructions, when executed by the at least one processor, cause the at least one processor to at least:
acquire an image to be detected; and
input the image to be detected into a detection model to acquire a detection result, wherein the detection model is trained by using the electronic device according to claim 17.

19. A non-transitory computer-readable storage medium comprising computer instructions stored therein, the computer instructions, when executed by a computer system, are configured to cause the computer system to at least:
generate an expanded sample image set for a target scene by using a mask image set and an initial sample image set, wherein the mask image set is acquired by parsing a predetermined image set, a target object in the target scene is interfered by another object or the target object in the target scene is cut off, and an image in the predetermined image set comprises the target object in the target scene or the another object; and
train a detection model, by using the initial sample image set and the expanded sample image set, for detecting the target object.

20. A non-transitory computer-readable storage medium comprising computer instructions stored therein, the computer instructions, when executed by a computer system, are configured to cause the computer system to at least:
acquire an image to be detected; and
input the image to be detected into a detection model to acquire a detection result, wherein the detection model is trained by using the non-transitory computer-readable storage medium according to claim 19.
